(19) United States
(12) Patent Application Publication
(10) Pub. No.: US 2025/0251757 A1
(43) Pub. Date: Aug. 7, 2025

(54) Charging Device for a User Computing Device

(71) Applicant: Google LLC, Mountain View, CA (US)

(72) Inventors: Thomas James Congdon, San Diego, CA (US); Mark Corbridge, Tiburon, CA (US); Ajmal Godil, San Diego, CA (US); Pieris Berreitter, San Francisco, CA (US)

(21) Appl. No.: 18/433,113

(22) Filed: Feb. 5, 2024

(51) Int. Cl. G06F 1/16; H02J 7/00

(52) U.S. Cl. CPC G06F 1/1632; G06F 1/163; H02J 7/00045; H02J 7/0044; H02J 7/00718; H02J 7/007188; H02J 2207/20; H02J 2207/30

(57) ABSTRACT

A charging device includes a plurality of pins and a first configured to perform operations, the operations comprising: in response to the plurality of pins physically contacting an object, determining, via an authentication operation, whether the object corresponds to a wearable computing device, in response to determining the object corresponds to the wearable computing device, communicating to the wearable computing device an available level of current for the charging device to provide to the wearable computing device, and providing the current to the wearable computing device.

### FIELD

The disclosure relates generally to charging devices and user computing devices which can be charged via the charging devices. More particularly, the disclosure relates to a charging device which communicates to a wearable computing device an available level of current for the charging device to provide to the wearable computing device.

### BACKGROUND

Existing charging devices (e.g., a docking station) can provide a charging current to a computing device.

### SUMMARY

Aspects and advantages of embodiments of the disclosure will be set forth in part in the following description, or can be learned from the description, or can be learned through practice of the example embodiments.

In an example embodiment, a charging device (e.g., a charger) is provided. The charging device includes a plurality of pins; and a first chip configured to perform operations, the operations comprising: in response to the plurality of pins physically contacting an object, determining, via an authentication operation, whether the object corresponds to a wearable computing device, in response to determining the object corresponds to the wearable computing device, communicating to the wearable computing device an available level of current for the charging device to provide to the wearable computing device, and providing the current to the wearable computing device.

In some implementations, the plurality of pins includes two pins.

In some implementations, the first chip comprises an integrated circuit.

In some implementations, the operations include performing the authentication operation by: determining whether a predetermined pulsed current pattern is received from the object, and in response to receiving the predetermined pulsed current pattern from the object, authenticating the object and determining the object corresponds to the wearable computing device.

In some implementations, the operations include performing the authentication operation by: exchanging cryptographic keys between the charging device and the object; and in response to a successful verification of the cryptographic keys, determining the object corresponds to the wearable computing device.

In some implementations, the operations include performing the authentication operation by: determining whether a predetermined tone signal is received from the object, and in response to receiving the predetermined tone signal from the object, authenticating the object and determining the object corresponds to the wearable computing device.

In some implementations, the charging device includes a moisture detection system configured to determine whether a resistance value indicating a moisture amount satisfies a threshold level at the plurality of pins.

In some implementations, when the moisture detection system determines the resistance value does not satisfy the threshold level, the operations comprise maintaining an output current level below a current threshold level, and when the moisture detection system determines the resistance value satisfies the threshold level, the operations comprise enabling the output current level to exceed the current threshold level.

In some implementations, the operations further comprise: while providing the current to the wearable computing device, monitoring a heartbeat signal output by the wearable computing device to determine whether the wearable computing device is removed from the plurality of pins, and changing a power state of the charging device to lower the current when the wearable computing device is determined to be removed from the plurality of pins.

In some implementations, communicating to the wearable computing device the available level of current comprises: providing a first voltage pattern to indicate a first current limit capability; and providing a second voltage pattern to indicate a second current limit capability.

In some implementations, communicating to the wearable computing device the available level of current comprises: providing a third voltage pattern to indicate a third current limit capability.

In some implementations, the first current limit capability is less than one amp, and the second current limit capability is more than one amp.

In some implementations, communicating to the wearable computing device the available level of current comprises: providing a first tone signal to indicate a first current limit capability; and providing a second tone signal to indicate a second current limit capability.

In some implementations, the operations further comprise: determining a current capability of a power source for the charging device based on a pull-up resistor value.

In some implementations, when the pull-up resistor value indicates a plurality of possible values for the current capability, determining the current capability of the power source for the charging device comprises ramping current from a first value for the current capability among the plurality of possible values to a second value for the current capability among the plurality of possible values and detecting whether a change in the current drops more than a threshold amount.

In some implementations, the first chip is a monolithic chip which includes a boost converter configured to negate a voltage drop across a charging cable used to provide the current to the wearable computing device.

In an example embodiment, a computing device (e.g., a smartphone, a tablet, a portable laptop, a wearable computing device, earbuds, etc.) is provided. The computing device includes a battery; and a first chip configured to perform operations, the operations comprising: in response to a plurality of pins of a charging device physically contacting the wearable computing device, performing an authentication operation with respect to the charging device, in response to the authentication operation being successfully performed, receiving a communication from the charging device indicating an available level of current for the charging device to provide to the wearable computing device, and configuring a supply of current received via the charging device to be provided to the battery based on the available level of current indicated by the communication.

In some implementations, the first chip comprises an integrated circuit.

In some implementations, performing the authentication operation comprises: drawing a predetermined current from the charging device via a pulsed current pattern.

In some implementations, performing the authentication operation comprises: exchanging cryptographic keys between the charging device and the wearable computing device; and in response to a successful verification of the cryptographic keys, authenticating the charging device.

In some implementations, performing the authentication operation comprises: transmitting a predetermined tone signal to the charging device for a predetermined duration of time.

In some implementations, the operations further comprise: while receiving the current, outputting a heartbeat signal to indicate the wearable computing device is present as a load on the charging device.

In some implementations, the communication includes a voltage pattern to indicate the available level of current for the charging device, a first voltage pattern indicates a first current limit capability, and a second voltage pattern indicates a second current limit capability.

In some implementations, the first current limit capability is less than one amp, and the second current limit capability is more than one amp.

In some implementations, the communication includes a predetermined tone signal to indicate the available level of current for the charging device, a first predetermined tone signal indicates a first current limit capability, and a second predetermined tone signal indicates a second current limit capability.

In an example embodiment, a computer-implemented method is provided. The computer-implemented method includes: in response to a plurality of pins of a charging device physically contacting an object, determining, via an authentication operation, whether the object corresponds to a wearable computing device; in response to determining the object corresponds to the wearable computing device, communicating to the wearable computing device an available level of current for the charging device to provide to the wearable computing device; and providing the current to the wearable computing device.

In an example embodiment, a computer-implemented method is provided. The computer-implemented method includes: in response to a plurality of pins of a charging device physically contacting a wearable computing device, performing an authentication operation with respect to the charging device; in response to the authentication operation being successfully performed, receiving a communication from the charging device indicating an available level of current for the charging device to provide to the wearable computing device; and configuring a supply of current received via the charging device to be provided to a battery of the wearable computing device based on the available level of current indicated by the communication.

In an example embodiment, a non-transitory computer-readable medium which stores instructions that are executable by one or more processors of a computing device is provided. The non-transitory computer-readable medium stores instructions which are executable by one or more processors of the computing device. The instructions include: in response to a plurality of pins of a charging device physically contacting an object, determining, via an authentication operation, whether the object corresponds to a wearable computing device; in response to determining the object corresponds to the wearable computing device, communicating to the wearable computing device an available level of current for the charging device to provide to the wearable computing device; and providing the current to the wearable computing device.

In an example embodiment, a non-transitory computer-readable medium which stores instructions that are executable by one or more processors of a computing device is provided. The non-transitory computer-readable medium stores instructions which are executable by one or more processors of the computing device. The instructions include: in response to a plurality of pins of a charging device physically contacting a wearable computing device, performing an authentication operation with respect to the charging device; in response to the authentication operation being successfully performed, receiving a communication from the charging device indicating an available level of current for the charging device to provide to the wearable computing device; and configuring a supply of current received via the charging device to be provided to a battery of the wearable computing device based on the available level of current indicated by the communication.

The non-transitory computer-readable medium may store additional instructions to execute other aspects and operations of the computing device and computer-implemented method as described herein.

These and other features, aspects, and advantages of various embodiments of the disclosure will become better understood with reference to the following description, drawings, and appended claims. The accompanying drawings, which are incorporated in and constitute a part of this specification, illustrate examples of the disclosure and, together with the description, serve to explain the related principles.

### BRIEF DESCRIPTION OF THE DRAWINGS

Detailed discussion of example embodiments directed to one of ordinary skill in the art is set forth in the specification, which makes reference to the appended drawings, in which:

FIGS. 1A-1D are example diagrams of a charging system (e.g., including a user computing device and charging device), according to one or more examples of the disclosure;

FIG. 2 is an illustration of an example circuit diagram for a charging system, according to one or more examples of the disclosure;

FIG. 3 illustrates example voltage patterns which can indicate different levels of available current, according to examples of the disclosure;

FIGS. 4A to 4C illustrate example processes for a charging device charging a user computing device, according to one or more examples of the disclosure;

FIG. 5 illustrates an operation diagram of an example charging system, according to examples of the disclosure;

FIG. 6 is a flow diagram of an example, non-limiting computer-implemented method according to one or more examples of the disclosure; and

FIG. 7 is a flow diagram of an example, non-limiting computer-implemented method according to one or more examples of the disclosure.

### DETAILED DESCRIPTION

Reference now will be made to embodiments of the disclosure, one or more examples of which are illustrated in the drawings. Each example is provided by way of explanation of the disclosure and is not intended to limit the disclosure. In fact, it will be apparent to those skilled in the art that various modifications and variations can be made to the disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

Example aspects of the disclosure are directed to a charging system which includes a charging device for a user computing device (e.g., a wearable computing device). In some implementations, the charging system provides for charging using a two-pin bidirectional interface and can include various capabilities including moisture detection capabilities, low power operating states, authentication capabilities, and disconnection monitoring capabilities.

For example, in some implementations an available current supplied by the charging device to the wearable computing device is greater than one amp (e.g., 1.5 amps).

For example, in some implementations the charging system includes a moisture detection system which is configured to detect whether a moisture amount at the output (e.g., at the plurality of pins) of the charging device satisfies a threshold level. If the moisture amount does not satisfy the threshold level, a high current path is prevented from being enabled. In some implementations, an indication may be provided (e.g., via a user interface) to the user of the wearable computing device that moisture has been detected and instructions may be provided to the user to take various actions to remove the moisture from the charging device. In some implementations, the plurality of pins of the charging device are externally exposed. In some implementations, the plurality of pins of the charging device may be covered.

For example, in some implementations an authentication operation is implemented such that the authentication protocol outputs a low current via a low power path under particular conditions (e.g., when a valid load is not detected) and outputs a high current under other particular conditions (e.g., when a valid load is detected) via a high current path.

For example, in some implementations a monitoring operation is implemented such that the charging device can detect whether the wearable computing device is removed from the charging device during a charging operation. For example, the wearable computing device may output a heartbeat signal to indicate attachment and when the charging device does not detect the heartbeat signal the charging device can resort to a low power state.

Example aspects of the disclosure provide several technical effects, benefits, and/or improvements in computing technology and the technology of computing devices and health monitoring devices. For example, according to one or more examples of the disclosure, a charging device having a two-pin interface can communicate an available current of an adapter that the charging device is connected to, for example, using predetermined voltage patterns. In addition, the charging device is configurable to supply over one amp of current to the user computing device for charging a battery of the user computing device, which is a greater amount than previous configurations. Further, to prevent corrosion and damage to the charging device and/or user computing device, a moisture detection system may be implemented to determine whether a moisture amount is excessive (e.g., via a resistance measurement at the output of the charging device). Further, power savings may be achieved and safety and/or security enhanced by operating the charging device in a low power state until the user computing device is authenticated. Further, power savings may be achieved and safety enhanced by operating the charging device in a low power state until the moisture detection test is passed. Further, power savings may be achieved and safety enhanced by operating the charging device in a low power state in response to the charging device not detecting a heartbeat signal within a predetermined duration of time while the user computing device is being charged.

In some implementations, the charging device includes a chip (e.g., an integrated circuit) which is a monolithic chip that, in the same logic chip, is configured to perform an authentication operation, a boost operation (e.g., via a boost converter, boost circuit), and power line communications for authentication handshaking and switching between low and high power paths. Therefore, a compact design of the chip can be achieved.

Therefore, aspects of the disclosure provide the technical effect, benefit, and/or improvements in computing technology and the technology of charging devices and computing devices (e.g., wearable computing devices) and health monitoring devices by efficiently, safely, and reliably providing a supply of power to a computing device from a charging device, as described herein.

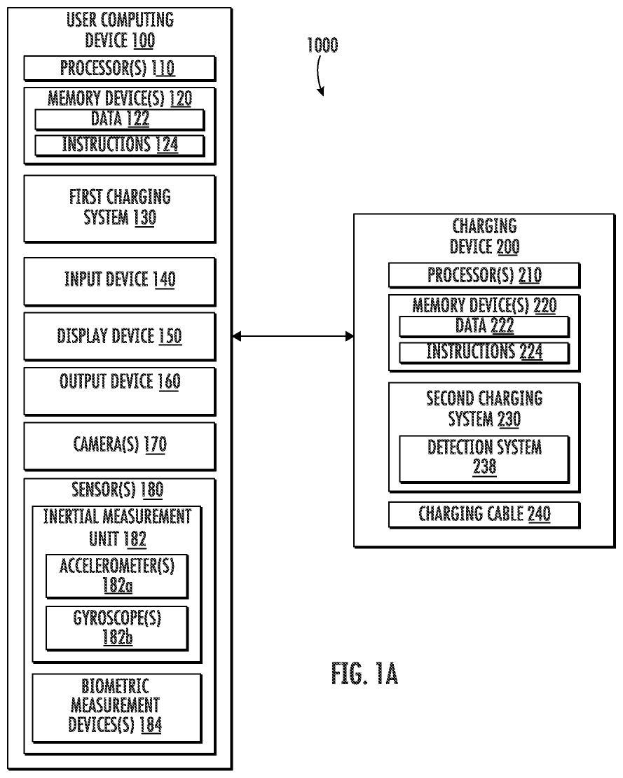

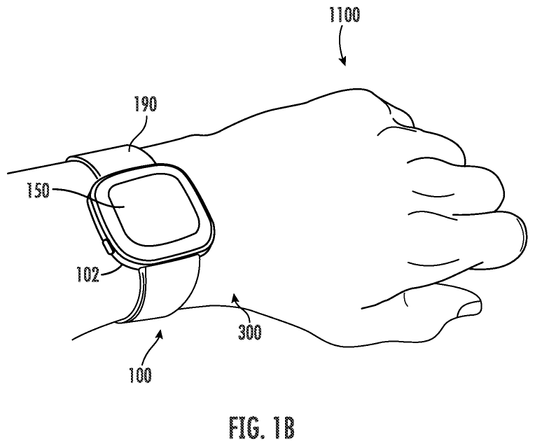

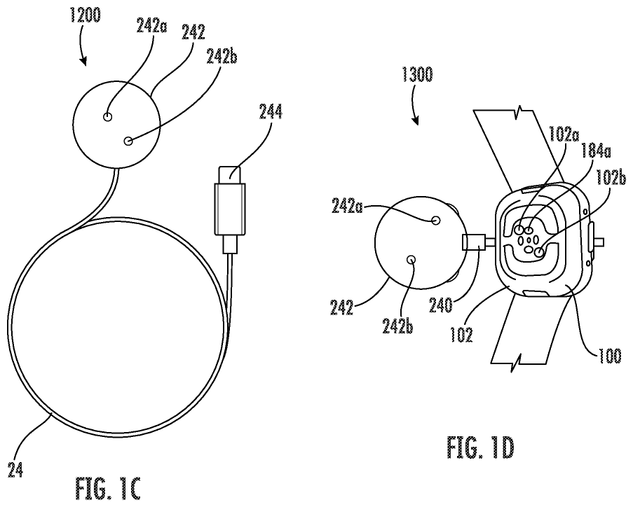

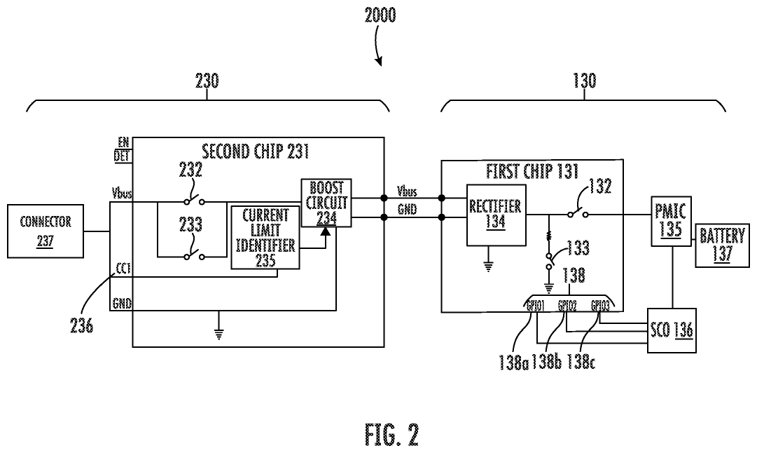

Referring now to the drawings, FIGS. 1A-ID are example diagrams of a charging system (e.g., including a user computing device and charging device), according to one or more examples of the disclosure. FIG. 2 is an illustration of an example circuit diagram for a charging system, according to one or more examples of the disclosure.

In FIG. 1A, the example charging system 1000 includes a user computing device 100 and a charging device 200. For example, the user computing device 100 and charging device 200 may be connected with one another in a wired manner (e.g., via a charging cable which can enable the charging device 200 to provide a charge to a battery of the user computing device 100 and to enable the charging device 200 and user computing device 100 to exchange information with one another). Any communications interfaces suitable for communicating may be utilized as appropriate or desired by the user computing device 100 and charging device 200.

The user computing device 100 may include a wearable computing device and may include a smart band, a smart watch, a smart patch, smart clothing, fitness tracker, and the like. In some implementations, the user computing device 100 may include a smartphone, a tablet, earbuds, etc., and other devices which can include a battery that is chargeable by a charging device according to the methods described herein. In some implementations, the user computing device 100 may include biometric measurement devices 184 including a pulse oximeter, heart rate monitor, blood pressure monitor, electrodermal activity sensor, glucometer, body temperature monitor, sleep tracker, electrocardiogram devices, and the like. The user computing device 100 may be configured to measure various biometrics, including biometrics associated with an ECG, PPG, heart rate, pulse information, BMI, heart rate variability, blood pressure, oxygen saturation, body temperature, sleep quality, physical activities (e.g., number of steps walked), and the like. Further, in some implementations the user computing device 100 may be configured to generate biometric information associated with an electrocardiogram, a photoplethysmogram, heart rate, blood pressure, oxygen saturation, respiration rate, body temperature, physical activity, a sleep metric, electrical conductance, and the like.

The charging device 200 may include a charging cable (e.g., a USB charging cable, for example, a USB type-C charging cable) that is connectable at one end to a device having a charging port (e.g., a charging adapter, a wall charger, charging station etc.), and connectable at another end to a computing device (e.g., the user computing device 100). The charging cable can receive power via the device having the charging port so that power can then be provided to the computing device (e.g., via connector pins).

Referring to FIG. 1B, according to some implementations of the disclosure, in the illustrated overview 1100 the user computing device 100 may correspond to a wearable computing device (e.g., a smartwatch) that can be worn by a user 300. For example, the front side of the user computing device 100 can include the display device 150 and include a fastener 190 (band) configured to secure the user computing device 100 to the user 300. For example, the fastener 190 may be connectable to a body 102 of the user computing device 100.

Referring to FIG. 1C, according to some implementations of the disclosure, in the illustrated overview 1200 the charging device 200 includes the charging cable 240. For example, the charging cable 240 can include a first end 242 having a plurality of pins (e.g., a first pin 242a and a second pin 242b) which can include a voltage or power line and a ground line, and can be configured to deliver power and data to the user computing device 100, for example.

Referring to FIG. 1D, according to some implementations of the disclosure, in the illustrated overview 1300 the user computing device 100 can include a plurality of ports or contacts (e.g., a first port 102a and a second port 102b) which can be configured to receive the power and the data delivered from the charging cable 240 via the plurality of pins (e.g., the first pin 242a and the second pin 242b). For example, the plurality of ports or contacts can be provided on a rear side of the body 102 of the user computing device 100 and may be provided proximate or adjacent to a plurality of biometric sensors which are also provided on the rear side of the user computing device 100 (e.g., PPG sensors 184a). As an example implementation, the plurality of pins provided at the first end 242 of the charging cable 240 may be aligned with the plurality of ports or contacts for the charging device 200 to charge the user computing device 100. In some implementations, an orientation at the interface between the plurality of pins and the plurality of ports or contacts can be reversed so that either input orientation may be recognized by the user computing device 100.

The user computing device 100 may include one or more processors 110, one or more memory devices 120, a first charging system 130, an input device 140, a display device 150, an output device 160, one or more cameras 170, and one or more sensors 180. One or more of the components of the user computing device 100 may be operatively connected with one another via a system bus. In some implementations, the user computing device 100 may include fewer or more components than that shown in FIG. 1A. For example, the user computing device 100 may not include the display device 150. For example, the system bus may be any of several types of bus structures that may further interconnect to a memory bus (with or without a memory controller), a peripheral bus, and/or a local bus using any of a variety of commercially available bus architectures.

The charging device 200 may include one or more processors 210, one or more memory devices 220, a second charging system 230, and a charging cable 240. One or more of the features of the charging device 200 may be operatively connected with one another via a system bus. For example, the system bus may be any of several types of bus structures that may further interconnect to a memory bus (with or without a memory controller), a peripheral bus, and/or a local bus using any of a variety of commercially available bus architectures.

For example, the one or more processors 110, 210 can be any suitable processing device that can be included in a user computing device 100 or charging device 200. For example, such a processor 110, 210 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 210 can be a single processor or a plurality of processors that are operatively connected, for example in parallel.

The one or more memory devices 120, 220 can include one or more non-transitory computer-readable storage mediums, such as such as a Read Only Memory (ROM), Programmable Read Only Memory (PROM), Erasable Programmable Read Only Memory (EPROM), and flash memory, a USB drive, a volatile memory device such as a Random Access Memory (RAM), an internal or external hard disk drive (HDD), floppy disks, a blue-ray disk, or optical media such as CD ROM discs and DVDs, and combinations thereof. However, examples of the one or more memory devices 120, 220 are not limited to the above description, and the one or more memory devices 120, 220 may be realized by other various devices and structures as would be understood by those skilled in the art.

For example, the one or more memory devices 120 can store instructions, that when executed, cause the one or more processors 110 to perform operations including: in response to a plurality of pins of a charging device physically contacting the user computing device 100, performing an authentication operation with respect to the charging device 200; in response to the authentication operation being successfully performed, receiving a communication from the charging device 200 indicating an available level of current for the charging device 200 to provide to the user computing device 100; and configuring a supply of current received via the charging device 200 to be provided to a battery of the user computing device 100 based on the available level of current indicated by the communication, as described according to examples of the disclosure.

For example, the one or more memory devices 220 can store instructions, that when executed, cause the one or more processors 210 to perform operations including: in response to a plurality of pins of the charging device 200 physically contacting an object, determining, via an authentication operation, whether the object corresponds to a user computing device 100; in response to determining the object corresponds to the user computing device 100, communicating to the user computing device 100 an available level of current for the charging device to provide to the user computing device 100; and providing the current to the user computing device 100, as described according to examples of the disclosure.

The one or more memory devices 120 can also include data 122 and instructions 124 that can be retrieved, manipulated, created, or stored by the one or more processors 110. In some examples, such data can be accessed and used as input to perform operations including: in response to a plurality of pins of a charging device physically contacting the user computing device 100, performing an authentication operation with respect to the charging device 200; in response to the authentication operation being successfully performed, receiving a communication from the charging device 200 indicating an available level of current for the charging device 200 to provide to the user computing device 100; and configuring a supply of current received via the charging device 200 to be provided to a battery of the user computing device 100 based on the available level of current indicated by the communication, as described according to examples of the disclosure.

The one or more memory devices 420 can also include data 422 and instructions 424 that can be retrieved, manipulated, created, or stored by the one or more processors 410. In some examples, such data can be accessed and used as input to perform operations including: in response to a plurality of pins of the charging device 200 physically contacting an object, determining, via an authentication operation, whether the object corresponds to a user computing device 100; in response to determining the object corresponds to the user computing device 100, communicating to the user computing device 100 an available level of current for the charging device to provide to the user computing device 100; and providing the current to the user computing device 100, as described according to examples of the disclosure.

The first charging system 130 can include any charging system which allows or is capable of receiving a charge for charging a power source (e.g., a battery) of the user computing device 100. Example components and operations of the first charging system 130 are described with respect to FIG. 2 herein.

The second charging system 230 can include any charging system which allows or is capable of providing or delivering a charge for charging a power source (e.g., a battery) of the user computing device 100. Example components and operations of the second charging system 230 are described with respect to FIG. 2 herein.

The user computing device 100 may include an input device 140 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or voice recognition sensor (e.g., a microphone to receive a voice command), a track ball, a remote controller, a portable (e.g., a cellular or smart) phone, and so on. The input device 140 may also be embodied by a touch-sensitive device or a touch-sensitive display device having a touchscreen capability. For example, the input device 140 may be used by a user of the user computing device 100 to provide an input to control a process of the charging operation of the user computing device 100. For example, the input may be a voice input, a touch input, a gesture input, a click via a mouse or remote controller, and so on.

In some implementations, the user computing device 100 may include a display device 150 which presents information viewable by the user, for example on a user interface (e.g., a graphical user interface). For example, the display device 150 may be a non-touch sensitive display. The display device 150 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example display devices and may include other types of display devices. For example, the display device 150 may be configured to provide a visual representation of a status of a charging operation, to provide an indication regarding the detection of moisture, to provide instructions to a user to perform an operation to remove the moisture, etc.

The user computing device 100 may include an output device 160 configured to provide an output to the user and may include, for example, one or more of an audio device (e.g., one or more speakers), a haptic device to provide haptic feedback to a user, a light source (e.g., one or more light sources such as LEDs which provide visual feedback to a user), the display device 150, and the like. For example, in some implementations of the disclosure the user may be provided with an output (e.g., via one or more of the speaker, haptic device, light source, display device, etc.) indicating a status of a charging operation, a status of the battery, indicating moisture detection, providing instructions to perform an operation to remove the moisture, etc.

The user computing device 100 may include one or more cameras 170. For example, the one or more cameras 170 may include an imaging sensor (e.g., a complementary metal-oxide-semiconductor (CMOS) or charge-coupled device (CCD)) to capture, detect, or recognize a user's behavior, figure, expression, etc. In some implementations, the one or more cameras 170 may be used to detect or capture an image of the user for determining biometric information of the user.

The user computing device 100 may include one or more sensors 180. For example, the one or more sensors 180 may include an inertial measurement unit 182 which includes one or more accelerometers 182a and/or one or more gyroscopes 182b. The one or more accelerometers 182a may be used to capture motion information with respect to the user computing device 100. The one or more gyroscopes 182b may also be used additionally or alternatively to capture motion information with respect to the user computing device 100. For example, the inertial measurement unit 182 may be configured as a six-axis or six-dimensional inertial measurement unit (e.g., a tri-axial accelerometer and a tri-axial gyroscope). The one or more sensors 180 may include one or more biometric measurement devices 184 which can be used to measure biometric information of a user. For example, the one or more biometric measurement devices 184 may include heart rate sensors, blood pressure sensors, ECG sensors, PPG sensors, galvanic skin sensors, blood oxygen sensors, body temperature sensors, respiration rate sensors, and the like. The inertial measurement unit 182 can also be used to measure biometric information of the user. The one or more sensors 180 may also include other sensors such as a magnetometer, GPS sensor, proximity sensor, optical sensors, force sensors, and the like.

Referring to FIG. 2, an example diagram of a charging system is illustrated, according to one or more examples of the disclosure. In FIG. 2, the charging system 2000 includes the first charging system 130 and the second charging system 230.

In an example implementation, the first charging system 130 may include a first chip 131, a power management integrated circuit (PMIC) 135, a system on chip (SoC) 136, and a battery 137. In the example implementation, the second charging system 230 may include a second chip 231, a connector 237, and a moisture detection system 238 (see FIG. 1A). In some implementations, the charging cable 240 may also be considered as part of, or correspond to, the second charging system 230.

The first chip 131 may correspond to an integrated chip (e.g., a monolithic integrated chip). The first chip 131 may include a first switch 132, a second switch 133, a rectifier 134, and a plurality of general-purpose input/output (GPIO) pins 138 (e.g., including first GPIO pin 138a, second GPIO pin 138b, and third GPIO pin 138c).

For example, the rectifier 134 may correspond to a bridge rectifier. The rectifier 134 may receive power from the second chip 231 via an interface having a plurality of pins (e.g., a two pin interface) carrying VBUS and GND. VBUS refers to the power supply voltage supplied via the charging device 200 and corresponds to the electrical power that is delivered (e.g., over a USB cable) to power and charge the user computing device 100. In some implementations, the VBUS voltage may be in the range of 4 volts to 6 volts, for example, about 4.2 volts to about 5.5 volts. In some implementations, the rectifier 134 may be configured to rectify the VBUS and GND inputs from either input orientation and provide information on the available charge current to the PMIC 135 and SoC 136 (e.g., via one or more of the plurality of GPIO pins 138. For example, the plurality of GPIO pins 138 may be used to convey digital signals which may include information related to the charging status, available charge current, etc., allowing the PMIC 135 and/or SoC 136 to adjust their behavior based on the charging conditions. In some implementations, the PMIC 135 may be configured to manage charging activities of the battery 137, regulate the charging process, monitor the status of the battery 137, ensure safe charging, etc. The SoC 136 may be configured to read the values of the plurality of GPIO pins 138 and may be configured to configure the PMIC 135 and registers of the battery 137 accordingly.

As an example implementation, when the first chip 131 detects a predetermined pulsed voltage pattern indicating the available charge current of the charging device 200, the first chip 131 may be configured to close the first switch 132 and configure one or more of the plurality of GPIO pins 138 to indicate the value of the available charge current. In some implementations, the first switch 132 may correspond to a transistor (e.g., a FET). For example, a first configuration for a first current value may be indicated by configuring the first GPIO pin 138a and the second GPIO pin 138b to have a same first value (e.g., a setting of GPIO1/2=00 corresponding to a value of 500 mA). For example, a second configuration for a second current value may be indicated by configuring the first GPIO pin 138a and the second GPIO pin 138b to have different values (e.g., a setting of GPIO1/2=01 corresponding to a value of 900 mA). For example, a third configuration for a third current value may be indicated by configuring the first GPIO pin 138a and the second GPIO pin 138b to have different values (e.g., a setting of GPIO1/2=10 corresponding to a value of 1.5 A). For example, a fourth configuration to indicate a fault status may be indicated by configuring the first GPIO pin 138a and the second GPIO pin 138b to have the same values (e.g., a setting of GPIO1/2=11). The disclosure is not limited to the above-described example configurations and may be alternated and other configurations of the GPIO pins and corresponding current values may be utilized.

As an example implementation, when the first chip 131 detects that VBUS is no longer being received, the first chip 131 may be configured to open the first switch 132, and in some implementations the second switch 133 may be opened. In some implementations, the second switch 133 may correspond to a transistor (e.g., a FET).

In some implementations, the first chip 131 may be configured to output a signal (e.g., a heartbeat signal) to indicate to the charging device 200 that the user computing device 100 is present. For example, the first chip 131 may be configured to output a current pulse or a voltage modulation heartbeat signal. In some implementations, the heartbeat signal may include a pulsed 100 mA signal which is provided at predetermined time intervals (e.g., every 100 ms) to indicate attachment or contact with the charging device 200. In some implementations the third GPIO pin 138c may be configured to provide as an input to either enable or disable the heartbeat signal. For example, the first chip 131 may be configured to enable the heartbeat signal in response to the first switch 132 being closed after the first chip 131 detects the predetermined pulsed voltage pattern indicating the available charge current of the charging device 200.

The second chip 231 may correspond to an integrated chip (e.g., a monolithic integrated chip). The second chip 231 may include a first switch 232, a second switch 233, a boost circuit 234, and a current limit identifier 235.

For example, the boost circuit 234 may correspond to a boost/bypass circuit (boost converter) that is configured to boost the VBUS voltage to a high enough level to overcome voltage droop on the user computing device 100 side, to ensure efficient and effective charging. The boost circuit 234 may include a bypass portion which is utilized during normal operating conditions when there is no significant voltage droop. The bypass portion allows the voltage to pass through without being boosted, enhancing efficiency of the second charging system 230. The boost circuit 234 may further be configured to be implemented in connection with the power line communication protocol (e.g., USB power delivery protocols) to allow for dynamic adjustments based on the negotiated power delivery parameters between the charging device 200 and the user computing device 100.

In some implementations, the current limit identifier 235 may be configured to detect a current limit which can be provided by a power source when the connector 237 is connected to the power source (e.g., via insertion of the connector 237 to a port of the power source). For example, the connector 237 may correspond to a USB charging cable, for example a USB type C charging cable. The current limit identifier 235 may be configured to, upon insertion of the connector 237 into the port, read a resistance value (e.g., a Rp value corresponding to a pull-up resistor value) on the CC1 pin 236 to determine the current limit (e.g., the USB adapter current limit) or current capability of the power source (adapter) for the charging device 200.

In some implementations, when the current limit identifier 235 detects the Rp value is 55K, the current limit identifier 235 may be configured to determine the current limit is a first value among a plurality of possible values (e.g., 500 mA or 900 mA). In some implementations, when the current limit identifier 235 detects the Rp value is 22K, the current limit identifier 235 may be configured to determine the current limit is a second value (e.g., 1.5 A). In some implementations, when the current limit identifier 235 detects the Rp value is 10K, the current limit identifier 235 may be configured to determine the current limit is a third value (e.g., 3.0 A).

For example, the current limit identifier 235 may be configured to determine whether the current limit is 500 mA or 900 mA when the detected Rp value is 55K (e.g., for a USB type C port). The current limit identifier 235 may be configured to determine whether the current limit is 500 mA or 900 mA by assuming an initial current limit of 500 mA and ramping the current linearly from 500 mA to 900 mA while simultaneously measuring the input voltage. If the measured input voltage drops below a threshold level (e.g., below 4.4 volts) or by a threshold amount (e.g., by more than ½ volts from an initial voltage level such as 5.0 volts), the current limit identifier 235 may be configured to determine the current limit as corresponding to 900 mA. If the measured input voltage drops does not below the threshold level (e.g., below 4.4 volts) or by the threshold amount (e.g., by more than ½ volts from an initial voltage level such as 5.0 volts), the current limit identifier 235 may be configured to determine the current limit as corresponding to 500 mA. In some implementations, the current limit identifier 235 may be configured to determine the current limit as 1.5 A when the Rp value is either 22K or 10K.

In some implementations, the second chip 231 may include two power (current) paths, including a low power (current) path and a high power (current) path. The second chip 231 may be configured to enable the low power path when a valid load (e.g., the user computing device 100) is not present (detected). The second chip 231 may be configured to enable (e.g., only enable) the high power path when a valid load (e.g., the user computing device 100) is present (detected). For example, when the low power path is enabled, the second chip 231 may be configured to limit the available current to be less than a first predetermined current level (e.g., 10 mA or less). The second chip 231 may be configured to configure the low power path by closing the first switch 232 and opening the second switch 233. The second chip 231 may be configured to configure the high power path by opening the first switch 232 and closing the second switch 233. In some implementations, the high power path may correspond to a low on-state resistance (RDS) path. For example, the resistance along the high power path may be 10 mohm or less.

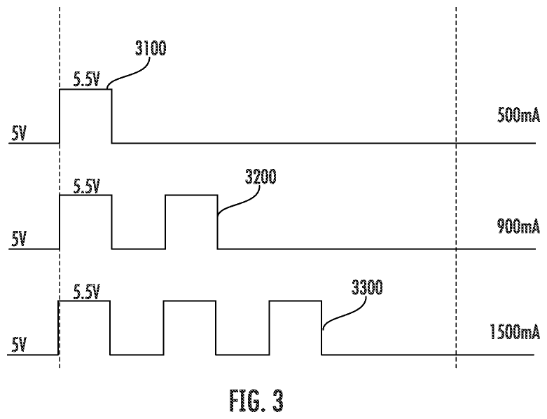

As described herein, the second chip 231 may be configured to output a predetermined voltage signal to indicate an available current that can be provided by the charging device 200 to the user computing device 100. For example, the predetermined voltage signal can correspond to a pulsed voltage pattern. FIG. 3 illustrates example voltage patterns which can indicate different levels of available current, according to examples of the disclosure.

In FIG. 3, a first voltage pattern 3100 includes pulsing a first voltage level a single time in a predetermined duration of time. For example, the first voltage level may be pulsed from 5 V to 5.5 V a single time over 100 ms, 200 ms, 300 ms, etc. For example, the first voltage pattern 3100 may indicate the available current is 500 mA.

In FIG. 3, a second voltage pattern 3200 includes pulsing the first voltage level two times in the predetermined duration of time. For example, the first voltage level may be pulsed from 5 V to 5.5 V two times over 100 ms, 200 ms, 300 ms, etc. For example, the second voltage pattern 3200 may indicate the available current is 900 mA.

In FIG. 3, a third voltage pattern 3300 includes pulsing the first voltage level three times in the predetermined duration of time. For example, the first voltage level may be pulsed from 5 V to 5.5 V three times over 100 ms, 200 ms, 300 ms, etc. For example, the third voltage pattern 3300 may indicate the available current is 1.5 A.

The disclosure is not limited to the example voltage patterns of FIG. 3, and other voltage patterns may be implemented to denote different available current levels. For example, different pulse frequencies (e.g., four times in the predetermined duration of time) and/or other voltage levels (e.g., pulsing from 4.5 V to 5 V or vice versa, etc.), may be implemented to denote different available current levels.

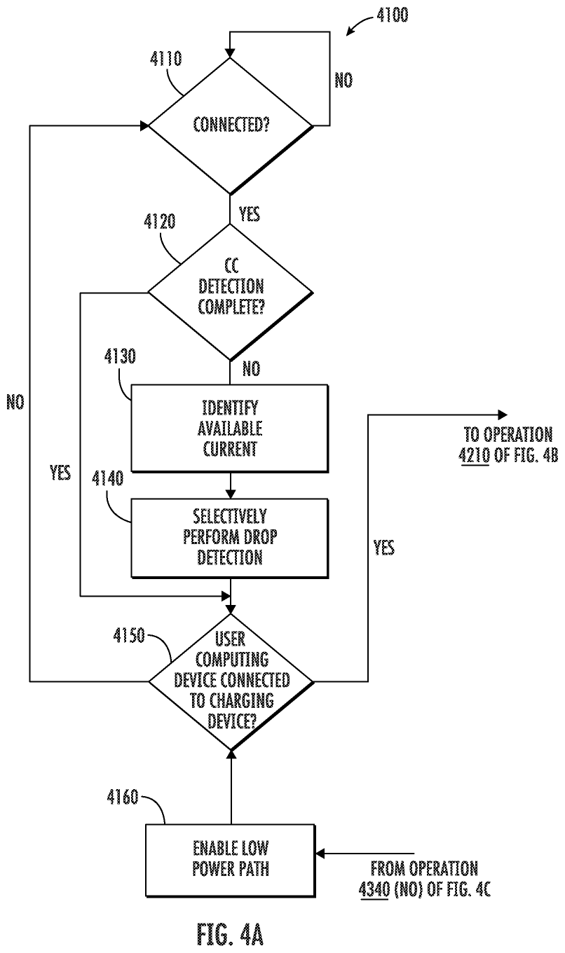

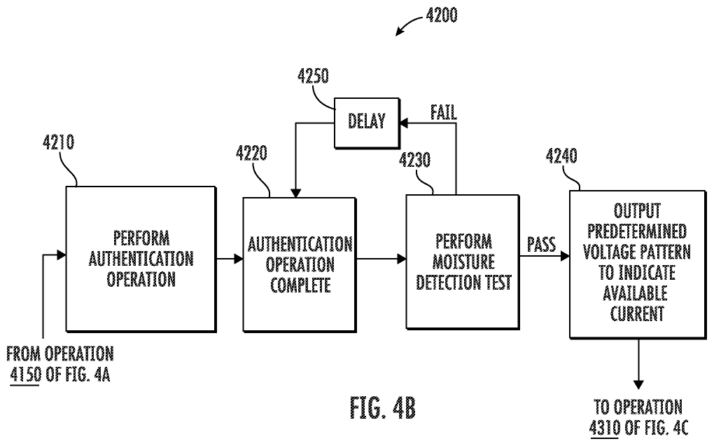

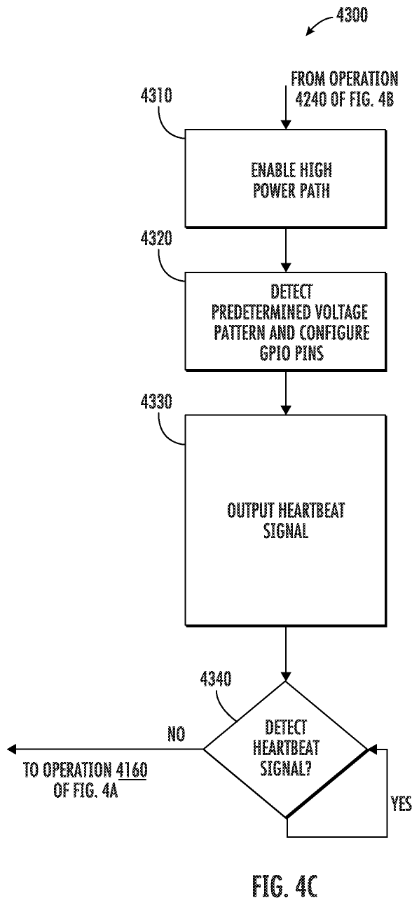

FIGS. 4A to 4C illustrate example processes for a charging device charging a user computing device, according to one or more examples of the disclosure. FIG. 4A illustrates a first process 4100, FIG. 4B illustrates a second process 4200, and FIG. 4C illustrates a third process 4300. However, it would be understood that each of the processes in FIGS. 4A to 4C can be combined together, for example to form a single process.

Referring to FIG. 4A, at operation 4110 of first process 4100 the charging device 200 (e.g., the second chip 231) is configured to determine whether the charging device 200 is connected, for example to a charging port of a power source (e.g., a USB type C charging port). When the charging device 200 is not connected, the charging device 200 may continue to repeat operation 4110. When the charging device 200 is connected, the first process 4100 may continue on to operation 4120.

At operation 4120 of first process 4100 the charging device 200 (e.g., the second chip 231) is configured to determine whether the charging device 200 has completed the detection of the configuration channel (CC). If so, the first process 4100 continues to operation 4150. If not, the first process 4100 continues to operation 4130 where the charging device 200 (e.g., the second chip 231) is configured to identify the available current (e.g., via current limit identifier 235). The current limit identifier 235 may be configured to, upon insertion of the connector 237 into the port, read a resistance value (e.g., a Rp value) on the CC1 pin 236 to determine the current limit (e.g., the USB adapter current limit). In some implementations, when the current limit identifier 235 detects the Rp value is 55K, the current limit identifier 235 may be configured to determine the current limit is a first value (e.g., 500 mA or 900 mA). In some implementations, when the current limit identifier 235 detects the Rp value is 22K, the current limit identifier 235 may be configured to determine the current limit is a second value (e.g., 1.5 A). In some implementations, when the current limit identifier 235 detects the Rp value is 10K, the current limit identifier 235 may be configured to determine the current limit is a third value (e.g., 3.0 A).

At operation 4140, the charging device 200 (e.g., the second chip 231) may be configured to selectively perform droop detection, based on the detected Rp value. For example, when the detected Rp value is 55K (e.g., for a USB type C port) the current limit may be either 500 mA or 900 mA. If the detected Rp value is not 55K (or is a value that does not correspond to more than one possible current limit value), operation 4140 may be skipped and the first process may continue on to operation 4150.

When operation 4140 is performed, the current limit identifier 235 may be configured to determine whether the current limit is 500 mA or 900 mA by assuming an initial current limit of 500 mA and ramping the current linearly from 500 mA to 900 mA while simultaneously measuring the input voltage. If the measured input voltage drops below a threshold level (e.g., below 4.4 volts) or by a threshold amount (e.g., by more than ½ volts from an initial voltage level such as 5.0 volts), the current limit identifier 235 may be configured to determine the current limit as corresponding to 900 mA. If the measured input voltage drops does not below the threshold level (e.g., below 4.4 volts) or by the threshold amount (e.g., by more than ½ volts from an initial voltage level such as 5.0 volts), the current limit identifier 235 may be configured to determine the current limit as corresponding to 500 mA. In some implementations, the current limit identifier 235 may be configured to determine the current limit as 1.5 A when the Rp value is either 22K or 10K.

At operation 4150 the user computing device 100 may be connected to or come into contact with the charging device 200. For example, the plurality of pins provided at the first end 242 of the charging cable 240 may be aligned with the plurality of ports or contacts for the charging device 200 to charge the user computing device 100.

When the user computing device 100 is connected to the charging device 200, the first process may continue on to operation 4210 of the second process 4200 of FIG. 4B.

Referring to FIG. 4B, at operation 4210 an authentication operation may be performed with respect to the charging device 200 and the user computing device 100.

In some implementations, the authentication operation may include the user computing device 100 (e.g., first chip 131), in response to the charging device 200 mating with the user computing device 100, sinking (drawing) current in a predetermined pattern. For example, the user computing device 100 may sink 10 mA current in a known (e.g., pulsed) pattern to indicate the presence of a load. For example, the user computing device 100 may sink the 10 mA current in the known (e.g., pulsed) pattern while VBUS is not connected to the PMIC 135 and the first switch 132 is open. The authentication operation can ensure that the charging device 200 does not switch to the high power path when the plurality of pins simply contact a piece of metal, as the detection of the sinking of current in the predetermined pattern indicates a valid load for charging purposes. Thus, in response to the plurality of pins physically contacting an object, the second chip 231 can determine, via the authentication operation, whether the object corresponds to the user computing device 100 or another object (e.g., that is not intended or meant to be charged or which may not be capable of being charged).

At operation 4220 the authentication operation can be completed, for example by the charging device 200 (e.g., second chip 231) being configured to successfully authenticate the user computing device 100 by detecting the sinking (drawing) of the current in the predetermined pattern. Thus, performing the authentication operation can include the second chip 231 determining whether a predetermined pulsed current pattern is received from the object (e.g., the user computing device 100), and in response to receiving the predetermined pulsed current pattern from the object (e.g., the user computing device 100), authenticating the object and determining the object corresponds to the user computing device 100. If the detection (authentication) fails, the charging device 200 (e.g., second chip 231) may be configured to maintain the low power path (e.g., outputting 5 volts at 10 mA) and determine that a valid load is not present (e.g., determine that the object does not correspond to the user computing device 100). In some implementations, the first chip 131 and/or second chip 231 may be configured to determine the authentication operation has failed if it is not completed within a predetermined duration of time (e.g., within 100 ms).

In some implementations, the authentication operation may additionally, or alternatively, include the user computing device 100 (e.g., first chip 131), in response to the charging device 200 mating with the user computing device 100, exchanging cryptographic keys with the charging device 200. The cryptographic keys (e.g., public and private keys) can be stored in respective memory devices of the user computing device 100 and charging device 200, for example. For example, the charging device 200 may exchange keys with another device, and in response to a successful verification of the cryptographic keys, determine the device corresponds to the user computing device 100. In some implementations, the charging device 200 (e.g., second chip 231) can authenticate the user computing device 100 in response to the user computing device 100 (e.g., first chip 131) encrypting a message using a public key of the charging device 200 and the charging device 200 decrypting the message using a private key of the charging device 200. In some implementations, the user computing device 100 (e.g., first chip 131) can authenticate the charging device 200 in response to the charging device 200 (e.g., second chip 231) encrypting a message using a public key of the user computing device 100 and the user computing device 100 decrypting the message using a private key of the user computing device 100.

At operation 4230, in response to a successful authentication operation at operation 4220, the charging device 200 may be configured to implement a moisture detection system 238 to perform a moisture detection test on the plurality of pins. The moisture detection test ensures that a bridge of liquid is not present on the plurality of pins. For example, the charging device 200 (e.g., the second chip 231) may be configured to detect whether moisture on the plurality of pins satisfies (e.g., is below) a threshold level (e.g., 50 k ohms, 300 k ohms, 700 k ohms, etc.) at the plurality of pins based on a resistance value between pins that is measured while a low voltage is applied.

If the moisture detection test fails, at operation 4250 a delay may be implemented (e.g., 100 ms, 500 ms, etc.) and operations 4220 and 4230 can be repeated (or a return to operation 4230 directly). For example, when the moisture detection system 238 determines the resistance value does not satisfy the threshold level, the second chip 231 may be configured to maintain an output current level below a current threshold level (e.g., maintain the low power path). In some implementations, the charging device 200 (e.g., second chip 231) may be configured to provide a communication to the user computing device 100 (e.g., first chip 131) indicating the presence of moisture at the plurality of pins. The user computing device 100 may be configured to provide an output via the output device 160 indicating the failure of the moisture detection test, providing instructions to wipe off the pins of the charging device 200 and/or the contacts of the user computing device 100, etc.

If the moisture detection test succeeds (or if the operation 4230 is omitted), at operation 4240 the charging device 200 (e.g., second chip 231) may be configured to communicate an available level of current for the charging device 200 to provide to the user computing device 100. For example, when the moisture detection system determines the resistance value satisfies the threshold level, the second chip 231 may be configured to enable the output current level to exceed the current threshold level (e.g., enable the high power path). For example, the charging device 200 (e.g., second chip 231) may be configured to output a predetermined voltage pattern to the user computing device 100 (e.g., first chip 131) to indicate the available current. For example, the second chip 231 may be configured to output a predetermined voltage signal to indicate an available current that can be provided by the charging device 200 to the user computing device 100. For example, the predetermined voltage signal can correspond to a pulsed voltage pattern. As already described herein, FIG. 3 illustrates example voltage patterns which can indicate different levels of available current, according to examples of the disclosure. However, the disclosure is not limited to the example voltage patterns of FIG. 3, and other voltage patterns may be implemented to denote different available current levels. For example, different pulse frequencies (e.g., four times in the predetermined duration of time) and/or other voltage levels (e.g., pulsing from 4.5 V to 5 V or vice versa, etc.), may be implemented to denote different available current levels.

As illustrated in FIG. 4B, the second process 4200 continues on to operation 4310 of the third process 4300 illustrated in FIG. 4C after the charging device 200 (e.g., second chip 231) communicates (e.g., via a power line communication protocol) the available level of current for the charging device 200 to provide to the user computing device 100. At operation 4310 the charging device (e.g., second chip 231) is configured to enable the high power path (e.g., enable a low RDS path by closing the second switch 233) and current can be provided to user computing device (e.g., the available level of current communicated to the user computing device 100).

At operation 4320, the first chip 131 may be configured to detect the predetermined voltage pattern and configure the plurality of GPIO pins 138 accordingly. For example, in some implementations the first chip 131 may be configured to power the VBUS input of the PMIC 135 by closing the first switch 132 (e.g., a low RD FET switch) from the rectifier 134 to the PMIC 135 VBUS input. In some implementations, a default current setting of 500 mA may be configured. The first chip 131 may be configured to provide the available level of current (e.g., the adapter current limit) to the SOC 136 via the plurality of GPIO pins 138 (e.g., first GPIO pin 138a and second GPIO pin 138b) and implement instructions to supply power (current) to the battery accordingly. In some implementations, if the first chip 131 does not receive the predetermined voltage signal (e.g., pulsed voltage pattern) from the second chip 231 within a predetermined duration of time (e.g., within one second), the first chip 131 may be configured to indicate a FAULT condition and configure the first GPIO pin 138a and second GPIO pin 138b accordingly and provide an output via the output device 160 indicating the FAULT condition. Example configurations of the first GPIO pin 138a and second GPIO pin 138b are shown in Table 1 below:

TABLE 1

| Adapter current limit | GPIO1 | GPIO2 |
|---|---|---|
| 500 mA (Default setting) | 0 | 0 |

| | | | |
|---|---|---|---|
| 900 | mA | 0 | 1 |
| 1500 | mA | 1 | 0 |

| | | |
|---|---|---|
| FAULT | 1 | 1 |

At operation 4330, the user computing device 100 (e.g., first chip 131) may be configured to output a heartbeat signal to indicate that the user computing device 100 is still attached to (e.g., connected to, mated with, etc.) the charging device 200. For example, the first chip 131 may be configured to pulse a predetermined current (e.g., 100 mA) load at a predetermined interval (e.g., every 100 ms) to indicate the attachment.

At operation 4340, the charging device 200 (e.g., second chip 231) may be configured to determine whether the heartbeat signal is detected. In some implementations, the charging device 200 (e.g., second chip 231) may be configured to, while providing the current to the user computing device 100, monitor the heartbeat signal output by the user computing device 100 to determine whether the user computing device 100 is removed from the plurality of pins, and to change a power state of the charging device 200 to lower the current when the user computing device 100 is determined to be removed from the plurality of pins. For example, the charging device 200 (e.g., second chip 231) may be configured to monitor for the presence of the heartbeat signal (e.g., via the power line communication protocol). If the heartbeat signal is detected by the charging device 200 (e.g., second chip 231), the charging device 200 (e.g., second chip 231) may be configured to repeat operation 4340. If the heartbeat signal is not detected by the charging device 200 (e.g., second chip 231), the charging device 200 (e.g., second chip 231) may be configured to determine that a disconnect event has occurred and operation 4160 (illustrated in FIG. 4A) may be performed. Thus, the charging device 200 (e.g., second chip 231) can detect when the user computing device 100 has been removed within a predetermined duration of time (e.g., within 100 ms).

At operation 4160, the charging device 200 (e.g., second chip 231) may be configured to enable the low power path in response to determining the disconnect event has occurred. For example, the charging device 200 (e.g., second chip 231) may be configured to lower the output voltage to 5V and switch to the low power path (e.g., the 10 mA low current path) and disable the high power path (e.g., the low RDS path), by switching the first switch 232 to the closed state and the second switch 233 to the open state. At the user computing device 100, in response to the disconnect event occurring and/or VBUS no longer being detected, the first chip 131 may be configured to open the first switch 132 and to configure the plurality of GPIO pins 138 to be in a high impedance state.

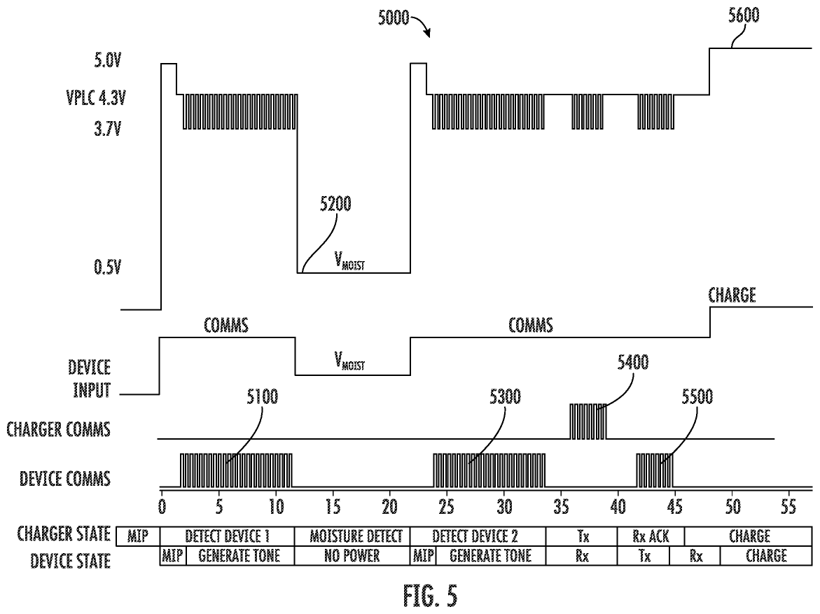

In another example implementation, FIG. 5 illustrates an operation diagram of an example charging system, according to examples of the disclosure. For example, FIG. 5 illustrates communication operations between the charging device 200 (e.g., second chip 231) and user computing device 100 (e.g., first chip 131) over a powerline where data and power are transmitted over a Power-line Communications (PLC) interface. For example, the charging device 200 (e.g., second chip 231) and user computing device 100 (e.g., first chip 131) may include similar transceiver circuits capable of transmitting and receiving a predetermined signal tone (e.g., about 2.5 kHz) with a predetermined amplitude range (e.g., varying between about 4.3V and about 3.7V). For example, the charging device 200 (e.g., second chip 231) and user computing device 100 (e.g., first chip 131) may be electrically coupled through a plurality of pins (e.g., pogo-pins).

In some implementations, the power path of the charging device 200 (e.g., second chip 231) may include a high efficiency boost regulator with resistor programmable output voltage in the range of 5.0V to 6.0V. For example, the boost regulator may be powered only after an authentication process between the charging device 200 (e.g., second chip 231) and the user computing device 100 (e.g., first chip 131) is completed and the user computing device 100 (e.g., first chip 131) is ready to be charged. Therefore, power savings may be achieved by delaying the powering on of the boost regulator.

In some implementations, at start-up (power-on, or a monitor input power (MIP) state)), the charging device 200 (e.g., second chip 231) may be configured to detect an advertised voltage on the configuration channel (CC) pins (e.g., CC1 and CC2). For example, if the voltage on both CC pins is below a certain threshold value, the charging device 200 (e.g., second chip 231) may be configured to determine that the current capability of the power source (e.g., the port to which the charging device 200 (e.g., second chip 231) is coupled), is 500 mA. For example, if the voltage on either of the CC pins is above the certain threshold value, the charging device 200 (e.g., second chip 231) may be configured to determine that the current capability of the power source (e.g., the port to which the charging device 200 (e.g., second chip 231) is coupled), is 1.5 A.

The charging device 200 (e.g., second chip 231) may be configured to detect the presence of the user computing device 100 (e.g., first chip 131). For example, in a first operating mode during which the charging device 200 (e.g., second chip 231) is configured to detect the user computing device 100 (e.g., first chip 131), the charging device 200 (e.g., second chip 231) may be configured to disable the boost regulator and limit the current to a first current level (e.g., via a low current path). For example, the first current level may be about 10 mA.

For example, in response to the charging device 200 (e.g., second chip 231) and the user computing device 100 (e.g., first chip 131) being coupled together (e.g., mating) and the user computing device 100 (e.g., first chip 131) receiving power from the charging device 200 (e.g., second chip 231), the user computing device 100 (e.g., first chip 131) is configured to generate a predetermined signal (e.g., tone) at a predetermined interval (e.g., a 2.5 kHz signal in 10 ms bursts) to advertise its presence. If the predetermined signal is received by the charging device 200 (e.g., second chip 231) for a predetermined duration of time (e.g., 10 ms, 20 ms, 30 ms, etc.) continuously, the charging device 200 (e.g., second chip 231) may be configured to determine the connection to the user computing device 100 (e.g., first chip 131) is valid. For example, as illustrated in FIG. 5 at 5100 the user computing device 100 (e.g., first chip 131) transmits a 2.5 kHz tone signal in a 10 ms burst.

In some implementations, in response to the charging device 200 (e.g., second chip 231) determining the connection to the user computing device 100 (e.g., first chip 131) is valid (e.g., the authentication operation is successful), the charging device 200 (e.g., second chip 231) is configured to perform moisture detection in a second operating mode (e.g., a moisture detection mode). For example, the moisture detection system 238 may be configured to perform moisture detection by decoupling the boost output capacitance from the output power pin, across which the moisture is detected (e.g., the VBUS output pin which may correspond to a VPLC pin). The charging device 200 (e.g., second chip 231) is configured to charge the user computing device 100 (e.g., first chip 131) only if the moisture detection system 238 does not detect moisture. For example, as illustrated in FIG. 5 at 5200 the charging device 200 (e.g., second chip 231) reduces an output voltage (e.g., to 0.5 V) to perform the moisture detection test and power is not applied to the user computing device 100 (e.g., first chip 131).

If the moisture detection system 238 detects moisture, the charging device 200 (e.g., second chip 231) is configured to transmit a moisture fail code to the user computing device 100 (e.g., first chip 131) and does not initiate charging. The charging device 200 (e.g., second chip 231) may be configured to continue testing for moisture intermittently, for example, for a predetermined duration of time (e.g., 1 second, 5 seconds, 10 seconds, etc.).

In response to the moisture detection system 238 not detecting moisture, the charging device 200 (e.g., second chip 231) may be configured to operate in a third operating mode (e.g., a current limit advertisement mode) and transmit data representing an amount of available current for charging (e.g., current limit information, USB current limits, etc.) to the user computing device 100 (e.g., first chip 131). In some implementations, the charging device 200 (e.g., second chip 231) may be configured to also transmit fault information (e.g., moisture detection pass/fail data) to the user computing device 100 (e.g., first chip 131). In some implementations, the charging device 200 (e.g., second chip 231) may be configured to perform another detection of the user computing device 100 (e.g., first chip 131) after completion of the moisture detection test and before transmission of the data representing the amount of available current for charging. For example, as illustrated in FIG. 5 at 5300 the user computing device 100 (e.g., first chip 131) again transmits the 2.5 kHz tone signal in the 10 ms burst. In response to receiving the second transmission of the predetermined tone signal, the charging device 200 (e.g., second chip 231) is configured to transmit the data representing the amount of available current for charging (e.g., current limit information, USB current limits, etc.) to the user computing device 100 (e.g., first chip 131). For example, as illustrated in FIG. 5 at 5400 the charging device 200 (e.g., second chip 231) transmits a predetermined tone (e.g., a code) which indicates the amount of current available for charging. In some implementations, a first predetermined tone may correspond to a first available current level (e.g., 500 mA) and a second predetermined tone may correspond to a second available current level (e.g., 1.5 A). As an example, the charging device 200 (e.g., second chip 231) may be configured to transmit the first predetermined tone according to a first encoding scheme (e.g., an encoding of 001 indicating 500 mA) and to transmit the second predetermined tone according to a second encoding scheme (e.g., an encoding of 010 indicating 1.5 A). In some implementations, the operation 5300 may be omitted and the charging device 200 (e.g., second chip 231) may be configured to transmit the data representing the amount of available current for charging (e.g., current limit information, USB current limits, etc.) to the user computing device 100 (e.g., first chip 131) in response to the moisture detection system 238 not detecting the moisture.

To acknowledge receipt of the data representing the amount of available current for charging, the user computing device 100 (e.g., first chip 131) may be configured to retransmit the data to the user computing device 100 (e.g., first chip 131). For example, as illustrated in FIG. 5 at 5500 the user computing device 100 (e.g., first chip 131) re-transmits the predetermined tone (e.g., the code) to acknowledge receipt of the predetermined tone.

In some implementations, in response to receiving the predetermined tone at 5400, the user computing device 100 (e.g., the first chip 131) may be configured to provide the available level of current (e.g., the adapter current limit) to the SOC 136 via the plurality of GPIO pins 138 (e.g., first GPIO pin 138a and second GPIO pin 138b) and implement instructions to supply power (current) to the battery accordingly. In some implementations, if the first chip 131 does not receive the predetermined tone from the second chip 231 within a predetermined duration of time (e.g., within one second), the first chip 131 may be configured to indicate a FAULT condition and configure the first GPIO pin 138a and second GPIO pin 138b accordingly and provide an output via the output device 160 indicating the FAULT condition. Example configurations of the first GPIO pin 138a and second GPIO pin 138b were described with respect to Table 1. In some implementations, the user computing device 100 (e.g., the first chip 131) may be configured to configure the plurality of GPIO pins 138 after re-transmitting the predetermined tone at 5500.

For example, in some implementations the re-transmitted data must be received by the charging device 200 (e.g., second chip 231) within a predetermined duration of time (e.g., within 10 ms) of the originally transmitted data, or the charging device 200 (e.g., second chip 231) may output a fault. After successful acknowledgment, the charging device 200 (e.g., second chip 231) may be configured to operate in a fourth operating mode (e.g., a charge mode) and activate the boost regulator to allow the user computing device 100 (e.g., first chip 131) to power on and be charged. For example, in the charge state the boost regulator is powered on and a voltage level may be changed from a first range to a second range (e.g., from a communication voltage range of 3.7 V to 4.3 V to a charge range of 5.0 V to 6.0 V as indicated in FIG. 5 at 5600).

In some implementations, while charging, the charging device 200 (e.g., second chip 231) is configured to monitor for a heartbeat signal (e.g., a periodic pulse) from the user computing device 100 (e.g., first chip 131), advertising its continued presence. For example, the heartbeat signal may have a predetermined amplitude and a predetermined period (e.g., an amplitude of 120 mA and period of 100 ms). For example, if the charging device 200 (e.g., second chip 231) fails to detect the heartbeat signal, the charging device 200 (e.g., second chip 231) may be configured to configure the low power (current) path and the user computing device 100 (e.g., first chip 131) resets.

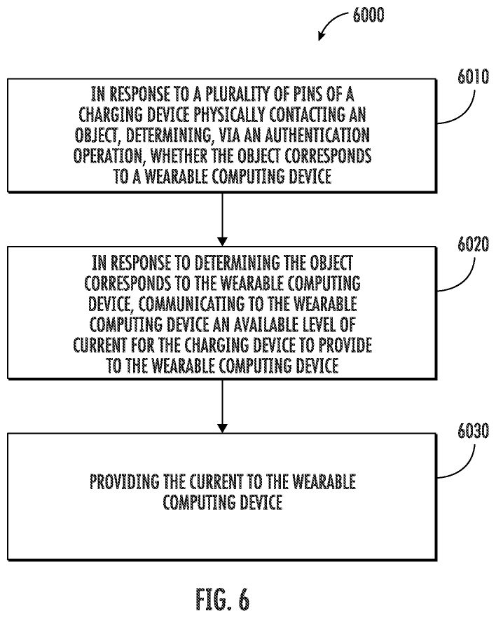

FIG. 6 is a flow diagram of an example, non-limiting computer-implemented method according to one or more examples of the disclosure.

The flow diagram of FIG. 6 illustrates a method 6000 for providing current to a user computing device (e.g., a wearable computing device) from a charging device, according to examples of the disclosure. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 6010, the method 6000 includes, in response to a plurality of pins of a charging device physically contacting an object, determining, via an authentication operation, whether the object corresponds to a wearable computing device. For example, as described herein, operations 4150, 4210, and 4220 of FIGS. 4A and 4B describe examples in which the plurality of pins of the charging device 200 come into contact with contacts or ports of the user computing device 100 to indicate that the user computing device 100 is attached to (connected to, mated with, coupled with, etc.) the charging device 200. For example, the authentication operation may include the user computing device 100 (e.g., first chip 131), in response to the charging device 200 mating with the user computing device 100, sinking (drawing) current in a predetermined pattern. For example, the user computing device 100 may sink 10 mA current in a known (e.g., pulsed) pattern to indicate the presence of a load. In another example, the authentication operation may additionally, or alternatively, include the user computing device 100 (e.g., first chip 131), in response to the charging device 200 mating with the user computing device 100, exchanging cryptographic keys with the charging device 200. In another example, the authentication operation may include the charging device 200 determining whether a predetermined tone signal is received from the object (e.g., the user computing device 100), and in response to receiving the predetermined tone signal from the object, authenticating the object and determining the object corresponds to the user computing device 100. The authentication operation can be implemented to determine whether the charging device 200 has simply contacted an object not intended to be charged (or capable of being charged), or has contacted an object that corresponds to the user computing device 100 (e.g., the wearable computing device).

At operation 6020, the method 6000 includes, in response to determining the object corresponds to the wearable computing device, communicating to the wearable computing device an available level of current for the charging device to provide to the wearable computing device. For example, as described herein, operation 4240 of FIG. 4B describes examples in which the charging device 200 (e.g., second chip 231) is configured to communicate an available level of current for the charging device 200 to provide to the user computing device 100 (e.g., wearable computing device). For example, the charging device 200 (e.g., second chip 231) may be configured to output a predetermined voltage pattern to the user computing device 100 (e.g., first chip 131) to indicate the available current. In some implementations, communicating to the user computing device 100 (e.g., the wearable computing device) the available level of current includes providing a first voltage pattern to indicate a first current limit capability, providing a second voltage pattern to indicate a second current limit capability, and providing a third voltage pattern to indicate a third current limit capability. In some implementations, communicating to the user computing device 100 (e.g., the wearable computing device) the available level of current includes providing a first tone signal to indicate a first current limit capability and providing a second tone signal to indicate a second current limit capability.

At operation 6030, the method 6000 includes the charging device providing the current to the wearable computing device. For example, as described herein, operations 4310 and 4320 of FIG. 4C describe examples in which the charging device 200 enables a high power path to supply the current to the user computing device 100 (e.g., the wearable computing device) and the user computing device 100 (e.g., the first chip 131) may be configured to detect the predetermined voltage pattern indicating the available level of current and configure the plurality of GPIO pins 138 accordingly so that a charge current is set for the battery 137 to be charged safely. In some implementations, when the charging device 200 enables a high power path to supply the current to the user computing device 100 (e.g., the wearable computing device), the user computing device 100 (e.g., the first chip 131) may be configured to detect the predetermined tone signal indicating the available level of current and configure the plurality of GPIO pins 138 accordingly so that a charge current is set for the battery 137 to be charged efficiently and safely.

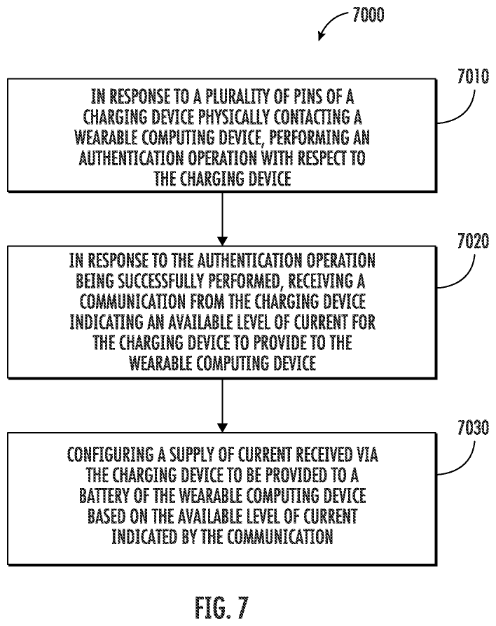

FIG. 7 is a flow diagram of an example, non-limiting computer-implemented method according to one or more examples of the disclosure.

The flow diagram of FIG. 7 illustrates a method 7000 for a user computing device (e.g., a wearable computing device) receiving current from a charging device, according to examples of the disclosure. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 7010, the method 7000 includes, in response to a plurality of pins of a charging device physically contacting a wearable computing device, performing an authentication operation with respect to the charging device. For example, as described herein, operations 4150, 4210, and 4220 of FIGS. 4A and 4B describe examples in which the plurality of pins of the charging device 200 come into contact with contacts or ports of the user computing device 100 to indicate that the user computing device 100 is attached to (connected to, mated with, etc.) the charging device 200. For example, the authentication operation may include the user computing device 100 (e.g., first chip 131), in response to the charging device 200 mating with the user computing device 100, sinking (drawing) current in a predetermined pattern. For example, the user computing device 100 may sink 10 mA current in a known (e.g., pulsed) pattern to indicate the presence of a load to the charging device 200. In another example, the authentication operation may additionally, or alternatively, include the user computing device 100 (e.g., first chip 131), in response to the charging device 200 mating with the user computing device 100, exchanging cryptographic keys with the charging device 200. In another example, the authentication operation may include the user computing device 100 (e.g., the wearable computing device) transmitting a predetermined tone signal to the charging device 200 for a predetermined duration of time. The authentication operation can be implemented to determine whether the charging device 200 has simply contacted an object not intended to be charged (or capable of being charged), or has contacted an object that corresponds to the user computing device 100 (e.g., the wearable computing device).

At operation 7020, the method 7000 includes, in response to the authentication operation being successfully performed, receiving a communication from the charging device indicating an available level of current for the charging device to provide to the wearable computing device. For example, as described herein, operation 4240 of FIG. 4B describes examples in which the user computing device 100 (e.g., wearable computing device) receives a communication from the charging device 200 (e.g., second chip 231) indicating an available level of current for the charging device 200 to provide to the user computing device 100. For example, the user computing device 100 (e.g., first chip 131) may receive a communication which includes a voltage pattern to indicate the available level of current for the charging device 200, where a first voltage pattern indicates a first current limit capability (e.g., less than one amp), a second voltage pattern indicates a second current limit capability (e.g., more than one amp), and a third voltage pattern indicates a third current limit capability (e.g., more than the first current limit capability and less than the second current limit capability). For example, the user computing device 100 (e.g., first chip 131) may receive a communication which includes a predetermined tone signal to indicate the available level of current for the charging device 200, where a first predetermined tone signal indicates a first current limit capability, and a second predetermined tone signal indicates a second current limit capability.

At operation 7030, the method 7000 includes configuring a supply of current received via the charging device to be provided to a battery of the wearable computing device based on the available level of current indicated by the communication. For example, as described herein, operations 4310 and 4320 of FIG. 4C describe examples in which the charging device 200 enables a high power path to supply the current to the user computing device 100 (e.g., the wearable computing device) and the user computing device 100 (e.g., the first chip 131) may be configured to detect the predetermined voltage pattern indicating the available level of current and configure the plurality of GPIO pins 138 accordingly so that a charge current is set for the battery 137 to be charged safely. In some implementations, when the charging device 200 enables a high power path to supply the current to the user computing device 100 (e.g., the wearable computing device), the user computing device 100 (e.g., the first chip 131) may be configured to detect a predetermined tone signal indicating the available level of current and configure the plurality of GPIO pins 138 accordingly so that a charge current is set for the battery 137 to be charged efficiently and safely.

For example, in some implementations the first chip 131 may be configured to power the VBUS input of the PMIC 135 by closing the first switch 132 (e.g., a low RD FET switch) from the rectifier 134 to the PMIC 135 VBUS input. In some implementations, a default current setting of 500 mA may be configured. The first chip 131 may be configured to provide the available level of current (e.g., the adapter current limit) to the SOC 136 via the plurality of GPIO pins 138 (e.g., first GPIO pin 138a and second GPIO pin 138b) and implement instructions to supply power (current) to the battery accordingly. In some implementations, if the first chip 131 does not receive the predetermined voltage signal (e.g., pulsed voltage pattern) from the second chip 231 within a predetermined duration of time (e.g., within one second), the first chip 131 may be configured to indicate a FAULT condition and configure the first GPIO pin 138a and second GPIO pin 138b accordingly and provide an output via the output device 160 indicating the FAULT condition. Example configurations of the first GPIO pin 138a and second GPIO pin 138b are shown in Table 1 above.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blue-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A charging device, comprising:
a plurality of pins; and
a first chip configured to perform operations, the operations comprising:
in response to the plurality of pins physically contacting an object, determining, via an authentication operation, whether the object corresponds to a wearable computing device,
in response to determining the object corresponds to the wearable computing device, communicating to the wearable computing device an available level of current for the charging device to provide to the wearable computing device, and
providing the current to the wearable computing device.

2. The charging device of claim 1, wherein the plurality of pins consists of two pins.

3. The charging device of claim 1, wherein the first chip comprises an integrated circuit.

4. The charging device of claim 1, wherein the operations include performing the authentication operation by:
determining whether a predetermined pulsed current pattern is received from the object, and
in response to receiving the predetermined pulsed current pattern from the object, authenticating the object and determining the object corresponds to the wearable computing device.

5. The charging device of claim 1, wherein the operations include performing the authentication operation by:
exchanging cryptographic keys between the charging device and the object; and
in response to a successful verification of the cryptographic keys, determining the object corresponds to the wearable computing device.

6. The charging device of claim 1, wherein the operations include performing the authentication operation by:
determining whether a predetermined tone signal is received from the object, and
in response to receiving the predetermined tone signal from the object, authenticating the object and determining the object corresponds to the wearable computing device.

7. The charging device of claim 1, further comprising:
a moisture detection system configured to determine whether a resistance value indicating a moisture amount satisfies a threshold level at the plurality of pins.

8. The charging device of claim 7, wherein
when the moisture detection system determines the resistance value does not satisfy the threshold level, the operations comprise maintaining an output current level below a current threshold level, and
when the moisture detection system determines the resistance value satisfies the threshold level, the operations comprise enabling the output current level to exceed the current threshold level.

9. The charging device of claim 1, wherein the operations further comprise:
while providing the current to the wearable computing device, monitoring a heartbeat signal output by the wearable computing device to determine whether the wearable computing device is removed from the plurality of pins, and
changing a power state of the charging device to lower the current when the wearable computing device is determined to be removed from the plurality of pins.

10. The charging device of claim 1, wherein communicating to the wearable computing device the available level of current comprises:
providing a first voltage pattern to indicate a first current limit capability; and
providing a second voltage pattern to indicate a second current limit capability.

11. The charging device of claim 9, wherein communicating to the wearable computing device the available level of current comprises:
providing a third voltage pattern to indicate a third current limit capability.

12. The charging device of claim 9, wherein
the first current limit capability is less than one amp, and the second current limit capability is more than one amp.

13. The charging device of claim 1, wherein communicating to the wearable computing device the available level of current comprises:
providing a first tone signal to indicate a first current limit capability; and
providing a second tone signal to indicate a second current limit capability.

14. The charging device of claim 1, wherein the operations further comprise:
determining a current capability of a power source for the charging device based on a pull-up resistor value.

15. The charging device of claim 13, wherein
when the pull-up resistor value indicates a plurality of possible values for the current capability, determining the current capability of the power source for the charging device comprises ramping current from a first value for the current capability among the plurality of possible values to a second value for the current capability among the plurality of possible values and detecting whether a change in the current drops more than a threshold amount.

16. The charging device of claim 1, wherein the first chip is a monolithic chip which includes a boost converter configured to negate a voltage drop across a charging cable used to provide the current to the wearable computing device.

17. A wearable computing device, comprising:
a battery; and
a first chip configured to perform operations, the operations comprising:
in response to a plurality of pins of a charging device physically contacting the wearable computing device, performing an authentication operation with respect to the charging device,
in response to the authentication operation being successfully performed, receiving a communication from the charging device indicating an available level of current for the charging device to provide to the wearable computing device, and
configuring a supply of current received via the charging device to be provided to the battery based on the available level of current indicated by the communication.

18. The wearable computing device of claim 17, wherein the first chip comprises an integrated circuit.

19. The wearable computing device of claim 17, wherein performing the authentication operation comprises:
drawing a predetermined current from the charging device via a pulsed current pattern.

20. The wearable computing device of claim 17, wherein performing the authentication operation comprises:
exchanging cryptographic keys between the charging device and the wearable computing device; and
in response to a successful verification of the cryptographic keys, authenticating the charging device.

21. The wearable computing device of claim 17, wherein performing the authentication operation comprises:
transmitting a predetermined tone signal to the charging device for a predetermined duration of time.

22. The wearable computing device of claim 17, wherein the operations further comprise:
while receiving the current, outputting a heartbeat signal to indicate the wearable computing device is present as a load on the charging device.

23. The wearable computing device of claim 17, wherein
the communication includes a voltage pattern to indicate the available level of current for the charging device,
a first voltage pattern indicates a first current limit capability, and
a second voltage pattern indicates a second current limit capability.

24. The wearable computing device of claim 20, wherein
the first current limit capability is less than one amp, and
the second current limit capability is more than one amp.

25. The wearable computing device of claim 17, wherein
the communication includes a predetermined tone signal to indicate the available level of current for the charging device,
a first predetermined tone signal indicates a first current limit capability, and
a second predetermined tone signal indicates a second current limit capability.

26. A computer-implemented method, comprising:
in response to a plurality of pins of a charging device physically contacting an object, determining, via an authentication operation, whether the object corresponds to a wearable computing device;
in response to determining the object corresponds to the wearable computing device, communicating to the wearable computing device an available level of current for the charging device to provide to the wearable computing device; and
providing the current to the wearable computing device.
